(19) United States
(12) Patent Application Publication
(10) Pub. No.: US 2024/0059485 A1
(43) Pub. Date: Feb. 22, 2024

(54) PRODUCT SELECTION SYSTEM

(71) Applicant: Aquabot Ltd., Afula (IL)

(72) Inventors: Yigal Natan RINGART, Givat Ela (IL); Shay GABRIELI, Ramat Yishai (IL)

(73) Assignee: Aquabot Ltd, Afula (IL)

(21) Appl. No.: 18/269,554

(22) PCT Filed: Jan. 16, 2022
(86) PCT No.: PCT/IL2022/050061

§ 371 Date: Jun. 25, 2023

Related U.S. Application Data
(60) Provisional application No. 63/138,479, filed on Jan. 17, 2021.

(51) Int. Cl. B65G 1/04; B65G 59/06; B65G 1/137

(52) U.S. Cl. CPC B65G 1/045; B65G 59/067; B65G 1/1378; B65G 2203/041

(57) ABSTRACT

A product selection system includes a robotic arm that is controllable to grip and manipulate product items of different types that are stored in a plurality of storage units that at least partially surround a central space in which the robotic arm is configured to operate. Each storage unit is configured to store a plurality of the product items. A controller is configured to control the robotic arm to remove each product item of an order of a plurality of the product items that are stored in the plurality of the storage units from the storage unit in which that product item is stored to an item conveyor for assembling of all of the plurality of product items of the order.

The present invention relates to automatic selection and loading systems. More particularly, the present invention relates to a product selection system for incorporation in various kinds of delivery and conveying systems.

### BACKGROUND OF THE INVENTION

Increasingly, items are ordered remotely, e.g., via the internet, smartphone applications, telephone, order management software provided by a warehouse or logistics company, or otherwise. Remote ordering enables a purchaser to order items from a convenient location, without the expense and time required to travel to and from a store. In particular, ordering of medications and other pharmaceutical products remotely may, in some cases, enable a person who is unable to travel (e.g., due to illness or other temporary or permanent disability) to obtain these products conveniently and in a timely manner. Therefore, warehouses, distribution centers, or other facilities that are tasked with fulfilling the orders must fulfill and deliver an increasing volume of orders with increasing speed

In order to enable rapid, accurate, and efficient selection and packing of items to fill orders, an order fulfillment facility may be automated to some extent. The automated equipment may be configured to select each item of the order (which may include multiple units of single item), and collect the items of a single order into a single container (e.g., bin, basket, box, bag, or other container). For example, an order to fill a medical prescription may include a single box of a medication, several boxes of a single type of medication, or several boxes of a variety of medications.

### SUMMARY OF THE INVENTION

There is thus provided, in accordance with an embodiment of the invention, a product selection system including: a robotic arm, the robotic arm controllable to grip and manipulate product items of different types that are stored in a plurality of storage units that at least partially surround a central space in which the robotic arm is configured to operate, each storage unit configured to store a plurality of the product items; and a controller that is configured to control the robotic arm to remove each product item of an order of a plurality of the product items that are stored in the plurality of the storage units from the storage unit in which that product item is stored to an item conveyor for assembling of all of the plurality of product items of the order.

Furthermore, in accordance with an embodiment of the invention, the system includes the plurality of storage units, wherein each of the storage units is configured to hold a stack of the product items of a single type, the different types of the product items being stored in different storage units of the plurality of storage units.

Furthermore, in accordance with an embodiment of the invention, each of the storage units includes a dispenser that is configured to dispense a product item that is stored within that dispenser.

Furthermore, in accordance with an embodiment of the invention, a mechanism for dispensing a stored product item from the vertical stack includes a piston that is configured to push a product item of the product items out of the stack through an opening in the dispenser toward the central space.

Furthermore, in accordance with an embodiment of the invention, the dispenser includes a magazine configured to store a plurality of the stacks of the product items.

Furthermore, in accordance with an embodiment of the invention, the magazine includes an advancing mechanism to displace a stack of the plurality of stacks when all of the product items stored in one of the stacks have been dispensed.

Furthermore, in accordance with an embodiment of the invention, the robotic arm is configured to remove a product item at a bottom of the stack and to grip the removed product item.

Furthermore, in accordance with an embodiment of the invention, the system includes a plurality of support racks, each support rack configured to support one or more storage units, each storage unit including an open storage bin configured to store a plurality of the product units of one or more types, wherein the controller is configured to operate the robotic arm to remove a selected product item from a plurality of product items that are stored in the storage bin.

Furthermore, in accordance with an embodiment of the invention, the system includes one or more sensors that are configured to sense data that is analyzable to identify a selected product item of the plurality of product items, wherein the controller is configured to analyze the sensed data to identify the selected product item.

Furthermore, in accordance with an embodiment of the invention, a sensor of the one or more sensors includes a camera, the data sensed by the camera including image data.

Furthermore, in accordance with an embodiment of the invention, a sensor of the one or more sensors is mounted on the robotic arm.

Furthermore, in accordance with an embodiment of the invention, the plurality of support racks are arranged in a plurality of tiers about the central space.

Furthermore, in accordance with an embodiment of the invention, each support rack of the plurality of support racks is sloped downward toward the central space such that when the storage bin is placed on a distal end of the support rack, the storage bin slides downward and inward toward the central space.

Furthermore, in accordance with an embodiment of the invention, a proximal end of the support rack includes a stopper that is configured to stop the inward sliding of the storage bin.

Furthermore, in accordance with an embodiment of the invention, the support rack includes rollers to facilitate the inward sliding of the storage bin.

Furthermore, in accordance with an embodiment of the invention, the system includes a disposal conveyor that is configured to convey an empty storage bin that is placed on the disposal conveyor to a disposal location.

Furthermore, in accordance with an embodiment of the invention, the system includes the item conveyor.

Furthermore, in accordance with an embodiment of the invention, the system includes a sensor to sense one or more properties of a selected product item that has been placed by robotic arm on the on the item conveyor.

Furthermore, in accordance with an embodiment of the invention, the system includes a labeler to label a selected product item that has been placed by the robotic arm on the item conveyor.

Furthermore, in accordance with an embodiment of the invention, the different types of the product items differ from one another by one or more characteristics selected from a group of characteristics consisting of size, shape, material, weight and external appearance.

There is further provided, in accordance with an embodiment of the invention, a method for controlling operation of a product selection system, the method including, by a controller: identifying a storage unit of a plurality of storage units in which each type of product item of an order of a plurality of the product items of different types that are stored in the plurality of the storage units is stored; operating a robotic arm that is located in a central space that is at least partially surrounded by the storage units to move each of the plurality of product items of the order from the storage unit in which that product item is stored to an item conveyor; and operating the item conveyor to convey each listed product item that is placed on the item conveyor for assembling of all of the plurality of product items of the order.

### BRIEF DESCRIPTION OF THE DRAWINGS

In order for the present invention to be better understood and for its practical applications to be appreciated, the following Figures are provided and referenced hereafter. It should be noted that the Figures are given as examples only and in no way limit the scope of the invention. Like components are denoted by like reference numerals.

FIG. 1 schematically illustrates an order fulfillment system that includes a plurality of circularly-arranged product selection systems, in accordance with an embodiment of the invention.

FIG. 2A schematically illustrates an example of a circularly arranged product selection system, in accordance with an embodiment of the invention.

FIG. 2B is a schematic top view of the circularly-arranged product selection system shown in FIG. 2A.

FIG. 3A schematically illustrates an example of a dispensing mechanism of the circularly arranged product selection system shown in FIG. 2A.

FIG. 3B schematically illustrates dispensing of an item by the dispensing mechanism shown in FIG. 3A.

FIG. 4 schematically illustrates an example of a robotic arm of he circularly-arranged product selection system shown in FIG. 2A.

FIG. 5A schematically illustrates an example of a variant of the robotic arm shown in FIG. 4 configured to remove a product item from a stack.

FIG. 5B schematically illustrates an example of the robotic arm shown in FIG. 5A when gripping a product item removed from a stack.

FIG. 6 schematically illustrates an example of a variant with two conveyors of the circularly-arranged product selection system shown in FIG. 2A.

FIG. 7 schematically illustrates an example of a variant of the product selection system shown in FIG. 2A with a translatable robotic arm.

FIG. 8 is a schematic top view of a variant of the circularly-arranged product selection system shown in FIG. 2, with dispensers of varying width.

FIG. 9A is a schematic top view of a variant of the circularly-arranged product selection system shown in FIG. 2, with items stored in a two-dimensional array in dispenser magazines.

FIG. 9B schematically illustrates a dispenser magazine of the circularly-arranged product selection system shown in FIG. 9A.

FIG. 9C schematically illustrates reloading of the dispenser magazine shown in FIG. 9B.

FIG. 10A schematically illustrates an example of a circularly-arranged product selection system in which items are stored in bins.

FIG. 10B is a schematic side view of the circularly-arranged product selection system shown in FIG. 10A.

FIG. 11A schematically illustrates a variant of the circularly-arranged product selection system shown in FIG. 10A, in which the open bins are arranged on one side of a conveyor track.

FIG. 11B is a schematic top view of the circularly-arranged product selection system shown in FIG. 11A.

FIG. 11C schematically illustrates a variant of the circularly-arranged product selection system shown in FIG. 11A.

FIG. 12 is a flowchart depicting a method of operation of a circularly-arranged product selection system, in accordance with an embodiment of the invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, the conjunction “or” as used herein is to be understood as inclusive (any or all of the stated options).

Some embodiments of the invention may include an article such as a computer or processor readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein.

In accordance with an embodiment of the invention, a circularly-arranged product selection system for inclusion in an order fulfillment system includes a robotic arm that is configured to grip and manipulate selected product items that are part of an order and that are stored in a plurality of item storage units within a volume in which the robotic arm may operate (e.g., within physical reach of the robotic arm). Each item storage unit is configured to store one or more types of different product items. For example, types of product items may differ from one another by their shape, size, material, weight, exterior markings or appearance, or other characteristics of the product or of a container that holds the product. The item storage units are arranged (e.g., in a cylindrical, concave or bowl shaped, polygonal, or other arrangement) to at least partially surround a central space. The robotic arm is located and configured to operate within the central space. For simplicity, any such arrangement of item storage units is hereby referred to as “circular.” Thus, any reference herein to a “circularly-arranged product selection system” should be understood as referring to any arrangement where item storage units for selection are stored at least partially surrounding a central space.

A controller of the order fulfillment system or of the circularly-arranged product selection system is configured to control the robotic arm to sequentially collect selected product items that are required to fill an order (e.g., received from an end user, from a retailer or distributor, or otherwise). The robotic arm may be controlled by the controller to move each selected product item an item storage unit in which the selected product item is stored to an item conveyor. The item conveyor is configured to convey the selected product item for assembly of all ordered product items into a form suitable for transport to a destination. For example, the item conveyor may convey the selected product items to a collection container in which product items that are part of a single order may be collected, or to a contiguous location on a conveyor.

The item conveyor may include a conveyor belt, a chute, track, or other device that is configured to convey a product item from a loading point where the item was loaded onto the conveyor, and an unloading point where the product item may be transferred to the collection container. The collection container may include a basket, box, crate, bag, sack, tray, or other type of container that is suitable for collecting the selected items.

In order to facilitate the selection of the items, the items for selection by the circularly-arranged product selection system are arranged to surround or partially surround the robotic arm, e.g., within physical reach of the robotic arm. The robotic arm is typically mounted, e.g., near the center of the circular arrangement of items, so as to enable three-dimensional motion about a base. The robotic arm may include one or more joints (providing a corresponding number of degrees of freedom), telescoping components, curved or straight rail, or other components that enable a distal grasping end of the robotic arm to reach the items that are arranged about the robotic arm.

In some examples, a distal end of the robotic arm may include an arrangement of one or more suction openings or (e.g., each opening surrounded by a cuplike or otherwise shaped elastic sealing structure) that are configured to grip a product item using applied suction. In some cases, the suction openings may be arranged in such a manner as to effectively grip product items of one or more types of shapes (e.g., with flat, convex, or otherwise shaped surfaces). For example, the suction openings may be arranged on a flexible or jointed surface such that the surface may adapt to the contours of the product item to be gripped. In other cases, the suction openings may be configured to grip a particular type of surface (e.g., a flat surface of a box or container).

Alternately or in addition, the distal end of the robotic arm may be provided with manipulable fingers, tongs, grippers, or other grasping structure that may be operated to mechanically grip an object. The distal end of the robotic arm may be configured to remove a product item from a stack (e.g., from the bottom of a vertical stack) of product items that are held in a dispenser or other holder.

The robotic arm may include, or communicate with, one or more imaging devices (e.g., two- or three-dimensional camera), proximity sensors, rangefinders, mapping sensors (e.g., laser based or otherwise), or other devices that enable or facilitate movement of the robotic arm to a particular product item, gripping of the product item, and movement of the product item to a destination (e.g., collection container or item conveyor).

For example, product items of a single type may be stored in a dispenser that is configured to dispense one or more product items. The robotic arm may grab the dispensed product items and place the grabbed product items on the item conveyor or directly in a collection container. In this case, operation of the robotic arm may be facilitated by arranging the dispensers in a circular cylindrical arrangement about the robotic arm. Each dispenser may be tiltable or otherwise openable or manipulable to facilitate replenishment of product items into the dispenser.

In another example, the product items for selection may be stored in a circular or other two- or three-dimensional arrangement of open bins (e.g., a concave or flat arrangement) that are arranged in one or more tiers or levels within the working space of the robotic arm. Such an arrangement (e.g., in which the product items are stored in a random arrangement within each bin) may facilitate replenishment of product items that are stored in a particular bin. The robotic arm may be configured to lift and grip a selected product item via the open side of the bin. For example, a bin may include a carton in which one or more types of product items are provided by a supplier of the product items, by a warehouse operator, or by others. In this case, the carton may be simply placed into the circular arrangement after removal of a top of the carton.

An item conveyor assembly for conveying to a collection container a product item that was placed on the item conveyer by the robotic arm may be configured to perform one or more actions on the product item. For example, an imaging system (e.g., one or more two- or three-dimensional cameras), barcode scanner, or one or more other types of sensors may verify that each selected product item corresponds to an ordered product item. Sensors may be configured to determine or verify an orientation of the product item that was placed on the item conveyor. The item conveyor assembly may include a labeler assembly for preparing a label and affixing the label to, or otherwise labelling or direct marking, a suitable location on the product item (e.g., a label containing prescription information in the case of prescribed medication).

Once ordered product items are added to the collection container, the collection container may be moved (e.g., on a container conveyor assembly) to another point. For example, the collection container may be conveyed to one or more other product selection systems, e.g., where different types of product items are stored, or other areas for loading, e.g., manual loading, of product items. The collection container may be conveyed to an inspection point where the collected product items may be inspected and verified automatically (e.g., by an automated vision product recognition system) or manually (e.g., by a pharmacist, e.g., as may be required by various laws or regulations regarding pharmaceutical products). The collection container may be conveyed to shipping point where the collected product items may be packed in packaging that is suitable for shipping (with or without the collection container), address labels may be prepared and affixed, and billing information may be generated.

A circularly-arranged product selection system in which a robotic arm selects product items from a circular arrangement, in accordance with an embodiment of the invention, may be advantageous over various other types of previously described order fulfillment systems.

For example, some prior art order fulfillment systems include an A-frame dispenser, in which a conveyor belt onto which product items are to be placed travels the entire length of the dispenser between the A-shaped walls of the dispenser before being deposited into a container. Product items for fulfilling the order are stored along (e.g., within or behind) the A-shaped walls. As the conveyor belt travels between the walls, product items that are ordered are dropped on the conveyor belt via the walls. The linear arrangement of such a dispenser typically would require a large amount of space (e.g., sufficient length to accommodate dispensers for all types of product items that may be ordered). The conveyor belt would be required to travel the entire length of the dispenser regardless of the number of product items that are to be dispensed (e.g., by gravity or by active expelling) onto the conveyor belt. Typically, the conveyor belt would be required to travel a sufficiently large distance between depositing product items related to successive orders in order to ensure that each product item is dispensed onto a location on the conveyor belt, and not onto a location where items related to a preceding or following order are to be dispensed. This required spacing could limit the number of product items per unit time that may be dispensed onto the conveyor belt.

On the other hand, in a circularly-arranged product selection system in which a robotic arm selects product items from a circular arrangement, in accordance with an embodiment of the invention, product items to be selected may be arranged compactly adjacent to a container conveyor along which collection containers are arranged. If necessary, more than one circularly-arranged product selection system may be located along the container conveyor, e.g., with each circular product selection system stocked with different product items. The circularly-arranged product selection system may enable automated verification, inspection, and labeling of a selected product item before that product item is placed in the appropriate collection container.

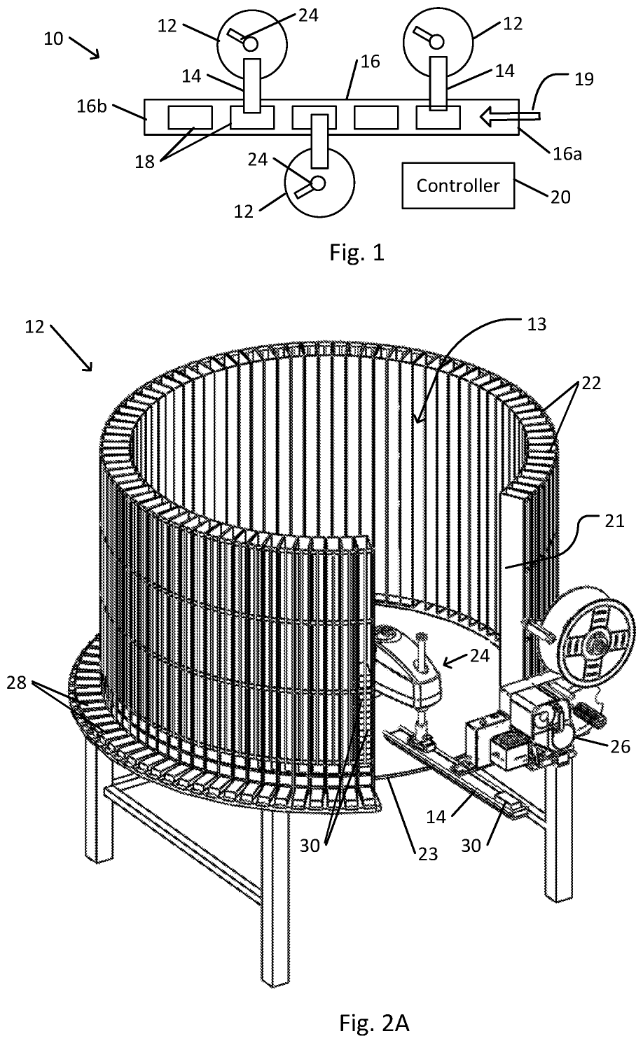

FIG. 1 schematically illustrates an order fulfillment system that includes a plurality of circularly-arranged product selection systems, in accordance with an embodiment of the invention.

In the example shown, order fulfillment system 10 includes a plurality of circularly-arranged product selection systems 12. Each circularly-arranged product selection system 12 is configured to store one or more product items. An item may be selected by operation of a robotic arm 24 of a circularly-arranged product selection system 12. Typically, the items are selected so as to fulfill an order, e.g., as entered into controller 20. Items that are selected by robotic arm 24 are placed onto a proximal end of item conveyor 14 of circularly-arranged product selection system 12.

In the example shown, product items that are placed onto item conveyor 14 are conveyed to a collection container 18 that is positioned at a distal end item conveyor 14. Typically, collection container 18 is moved successively to distal ends of one or more item conveyors 14 by container conveyor 16. Although container conveyor 16 is linear in the example shown, a container conveyor 16 may follow a three dimensional path that may include curves, intersections, upgrades, downgrades, elevators, or other components that may convey a collection container 18 in three dimensions. Alternatively or in addition, the collected items may be placed together as a batch on a conveyor (e.g., similar to container conveyor 18), with sufficient space between batches on the conveyor to provide a clear demarcation of the beginning and end of each batch.

For example, each collection container 18 may be placed onto container conveyor 16 at one of one or more starting positions 16a, and may be conveyed in a direction indicated by arrow 19 to an item conveyor 14 of one or more circularly-arranged product selection systems 12. In other examples, container conveyor 16 may include a nonlinear arrangement (e.g., an arrangement of turntables, intersecting conveyor sections, or other arrangement) that may convey a collection container 18 to different item conveyors 14 in a nonlinear order, e.g., as determined by availability of a particular circularly-arranged product selection system 12, or otherwise. Each circularly-arranged product selection system 12 may be operated by controller 20 to place any selected items that are stored by that circularly-arranged product selection system 12 into the collection container 18 that is currently located at the item conveyor 14 of that circularly-arranged product selection system 12.

When all items of an order are placed into collection container 18 by one or more circularly-arranged product selection systems 12, collection container 18 may be conveyed by container conveyor 16 to a removal point 16b. At removal point 16b, collection container 18 may be removed from container conveyor 16 for one or more types of further processing. For example, further processing may include manual or automatic inspection or verification of items in the order (which may be required by regulatory rules in the case that the items include pharmaceutical items), manual loading of additional product items, packing or repacking for shipment, transport to another order fulfillment system 10, or for shipping to a final destination (e.g., to a client that placed the order), or other processing. Conveyor 16 may be a part of a larger sorting system or an entire conveying grid of an order fulfillment system 10, e.g., that includes a plurality of conveyors or sections.

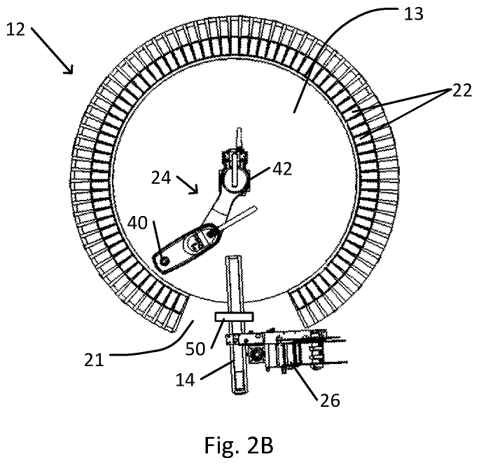

Controller 20 may represent a single controller or computer, e.g., that includes a processor, data storage, and communication units for communication with one or more devices (e.g., including robotic arm 24, item conveyor 14, container conveyor 16, labeler 26 (FIG. 2A), sensor 50 (FIG. 2B), order input, and any other sensing or controllable components of order fulfillment system 10). Alternatively, controller 20 may represent two or more intercommunicating controllers or computers, e.g., each associated with one or more components of order fulfillment system 10. Controller 20 may operate as a standalone system, or may be connected to, or represent a hardware or software module of, a main computing system of a facility.

FIG. 2A schematically illustrates an example of a circularly-arranged product selection system, in accordance with an embodiment of the invention. FIG. 2B is a schematic top view of the circularly-arranged product selection system shown in FIG. 2A.

In the example shown, circularly-arranged product selection system 12 includes a robotic arm 24 that is located within central space 13. Robotic arm 24 extends from a point near the center of a circular cylindrical arrangement of item storage units in the form of item dispensers 22 that partially surround central space 13. Item dispensers 22 are arranged around the perimeter of floor surface 23 of circularly-arranged product selection system 12, (in the example shown at a height that is above the floor of the building or room in which circularly-arranged product selection system 12 is located), except at conveyor gap 21. Each item dispenser 22 includes a vertical stack of product items 30. When a product item 30 is dispensed by an item dispenser 22, robotic arm 24 may be operated to grip the dispensed product item 30 and place that product item 30 on a proximal end of item conveyor 14.

In the example shown, arm base 42 of robotic arm 24 is located approximately at the center of a circular perimeter of central space 13 that is formed by the inward facing ends of item dispensers 22. Robotic arm 24 is configured such that gripper 40 may be manipulated to grip any product item 30 that is dispensed by any of item dispensers 22, and to deposit that gripped product item 30 on a proximal end of item conveyor 14. Item conveyor 14 may then convey the deposited product item 30 distally through conveyor gap 21 to a collection container 18 that is positioned at a distal end of item conveyor 14. In conveying product item 30 distally, product item 30 may be sensed by sensor 50 (e.g., on all or some sides) and may be labeled by labeler 26.

In another example, a circularly-arranged product selection system similar to circularly-arranged product selection system 12 may include a full circle of item dispensers 22 without a conveyor gap 21. For example, item conveyor 14 may be located below floor surface 23. In this case, floor surface 23 may include an opening through which a dispensed product item 30 may be delivered to item conveyor 14. In some examples, floor surface 23 may be sloped (e.g., funnel-shaped) toward the opening to enable product item 30 that is placed anywhere on floor surface 23 to slide to the opening and onto item conveyor 14. In this case, container conveyor 16 may also be located below the height of floor surface 23.

Each item dispenser 22 may be configured to enable replenishment of product items 30 in that item dispenser 22 without, or minimally, interrupting operation of that item dispenser 22. For example, each item dispenser 22 may include an opening at the top or on an outward-facing surface through which one or more product items 30 may be added to a stack of product items 30 within item dispenser 22. Alternatively or in addition, an entire cassette of pre-loaded product items 30 may be inserted into an item dispenser 22 when the supply of product items 30 in that item dispenser 22 has been depleted (or nearly so).

In some examples, item conveyor 14 may be operated to move product item 30 past one or more sensors 50. For example, sensor 50 may include one or more of a camera or other imaging device, a barcode scanner, a radiofrequency identification (RFID) sensor, a scale, or another type of sensor. Thus, sensor 50 may be configured to read information that is encoded on an identifying tag or labelling on a product item 30 (e.g., one- or two-dimensional barcode, RFID tag, alphanumeric text, symbols graphics or artwork, or other identifying markings or labels), detect and orientation of product item 30 relative to item conveyor 14, or other information that characterizes product item 30.

In some examples, item conveyor 14 may be configured to bring a product item 30 to labeler 26. For example, labeler 26 may be configured to print a label based on one or more of information sensed by sensor 50, information regarding product item 30 that was input into controller 20 (e.g., prescription information, usage instructions, or other information), data regarding product item 30 that is stored in a database that is associated with controller 20 (e.g., pricing information, handling instructions, or other information), or otherwise obtained information. The printed label may include alphanumeric characters, symbols, barcodes, coloring, or other printed labeling. Alternatively or in addition, labeler 26 may be configured to otherwise label a product item 30 (e.g., by affixing an RFID tag or other non-printed label, by laser etching, direct printing onto product item 30, or otherwise).

Item conveyor 14 may then convey product item 30 to the distal end of item conveyor 14, where product item 30 may be placed into a collection container 18 that is located at the distal end of item conveyor 14, or may otherwise be conveyed (e.g., without a collection container) to a processing location for further processing (e.g., for shipping, possibly preceded by one or more operations in preparation for shipping).

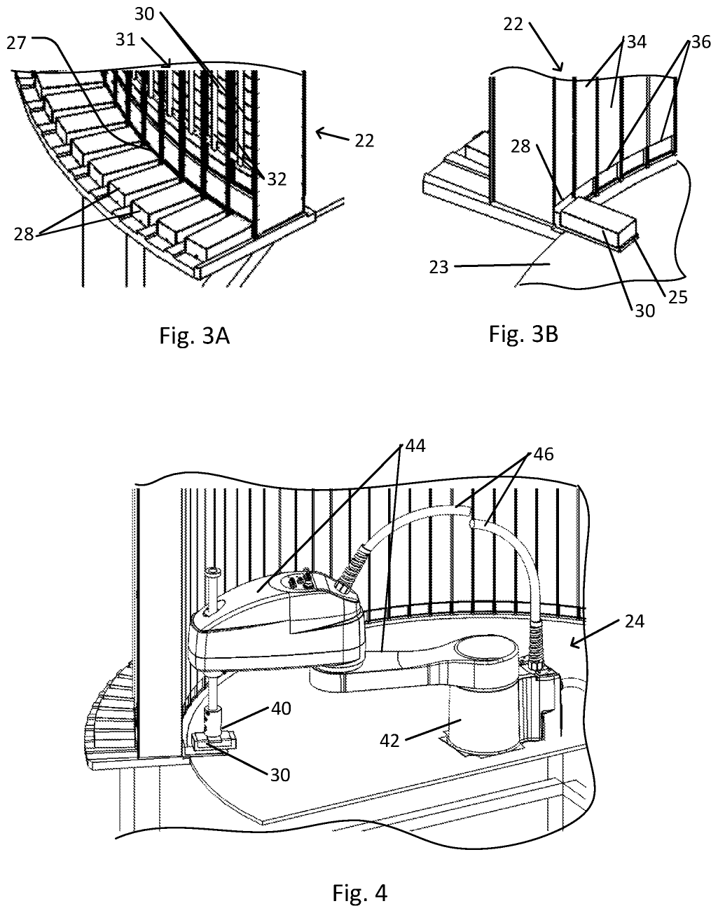

FIG. 3A schematically illustrates an example of a dispensing mechanism of the circularly-arranged product selection system shown in FIG. 2A. FIG. 3B schematically illustrates dispensing of an item by the dispensing mechanism shown in FIG. 3A.

In the example shown, product items 30 are stacked vertically in a vertical stack 31 in each item dispenser 22. Product items 30 are confined to vertical stack 31 by rods 32, and by inner wall 34, except at inward-facing opening 36. Typically, the height of inward-facing opening 36 is approximately equal to (typically, slightly higher than to allow unimpeded passage of product item 30 through inward-facing opening 36) the height of a single product item 30. In some cases, the height of inward-facing opening 36 may be slightly greater than a stack of two, or another predetermined number of, product items 30.

In the example shown, each item dispenser 22 is provided with a dispensing piston 28. When product item 30 is not being dispensed, dispensing piston 28 lies next to an outer face of item dispenser 22 (e.g., as in FIG. 3A). When one or more product items 30 are to be dispensed from item dispenser 22, dispensing piston 28 may be inserted into item dispenser 22 through an outward-facing opening 27 of item dispenser 22. Insertion of dispensing piston 28 into item dispenser 22 (e.g., as in FIG. 3B) may push one or more product items 30 out of vertical stack 31 inward through inward-facing opening 36 of inner wall 34 onto floor surface 23 of central space 13. Alternatively or in addition, a dispensed product item 30 may be supported within central space 13 by a dispenser tray 25 that is attached to an inner side of dispensing piston 28, or is configured to move inward in tandem with dispensing piston 28.

When a product item 30 has been pushed inward onto floor surface 23, product item 30 may be gripped by robotic arm 24.

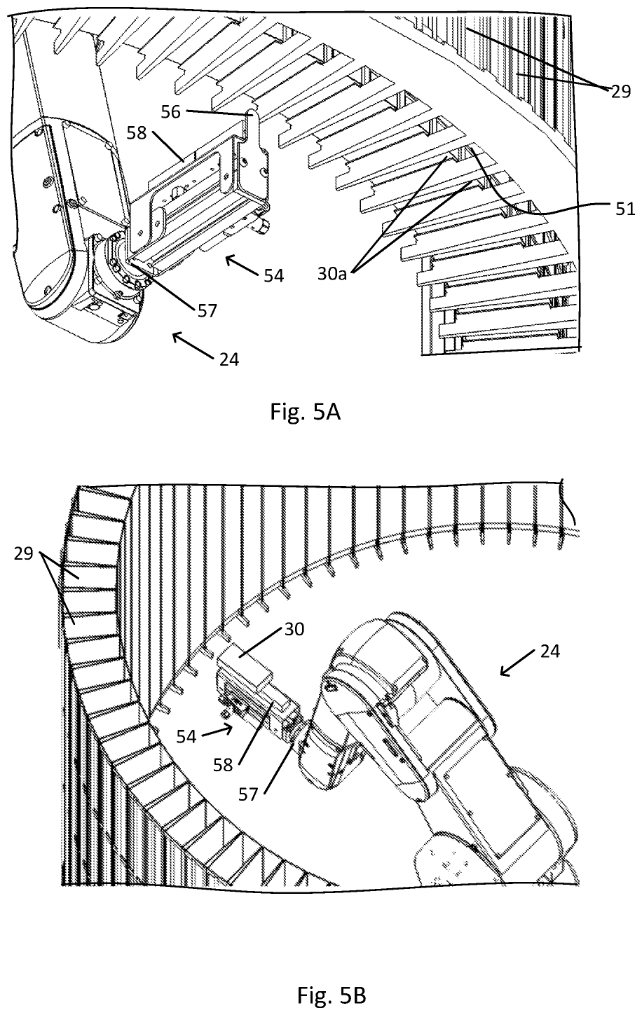

FIG. 4 schematically illustrates an example of a robotic arm of he circularly-arranged product selection system shown in FIG. 2A.

In the example shown, robotic arm 24 (e.g., a Selective Compliance Articulated Robot Arm, or SCARA) extends from arm base 42 that is fixed relative to circularly-arranged product selection system 12. One or more arm segments 44 extend from arm base 42. Each arm segment 44 is rotatable relative to one or more of arm base 42 and any adjacent arm segments 44. Gripper 40 is connected to a distal end of arm segments 44. Therefore, controlled rotation of one or more arm segments 44, e.g., relative to arm base 42 or to adjacent arm segments 44, may manipulate gripper 40 to various locations (typically all locations) within circularly-arranged product selection system 12 (e.g., within a perimeter defined by item dispensers 22). One or more components of robotic arm 24 may be powered by an external power source, e.g., via power cables 46.

In some examples, gripper 40 may be configured to grip a dispensed product item 30 by application of suction to a surface of product item 30. For example, suction to gripper 40 may be provided via one or more hoses. In other examples, gripper 40 may include mechanical structure (e.g., manipulable fingers or other manipulable structure) that is configured to mechanically grip a product item 30. Typically, the gripped product item 30 may be manipulated by robotic arm 24 for placement in a predetermined orientation on item conveyor 14. When product item 30 is placed above item conveyor 14, gripper 40 may be operated to release product item 30.

In some examples, product item 30 may be stored in a stack in a structure that does not include a dispensing mechanism. In this case, robotic arm 24 may be configured to remove a product item 30 from the stack.

FIG. 5A schematically illustrates an example of a variant of the robotic arm shown in FIG. 4, configured to remove a product item from a stack.

In the example shown, product items 30 are stored in vertical stacks in a plurality of item stack holders 29 (whose structure may be similar to that of item dispensers 22, but without any dispensing mechanism such as dispensing piston 28).

In the example shown, a distal end of robotic arm 24 (e.g., articulated robot) is provided with grasping assembly 54. Rotation mechanism 57 is operable to rotate grasping assembly 54 about its longitudinal axis relative to proximal components of robotic arm 24. Grasping assembly 54 is configured to remove a bottom item 30a from the bottom of a stack of product items 30 that are stored in an item stack holder 29.

In the example shown, grasping assembly 54 includes finger 56 and suction surface 58. Finger 56 is configured to be inserted into space 51 that is formed between an outer end of bottom item 30a and an outer end of item stack holder 29. The insertion of finger 56 into space 51 may bring suction surface 58 into contact with a bottom surface of bottom item 30a.

After insertion of finger 56 into space 51, inward (proximal) motion of grasping assembly 54 may pull bottom item 30a inward and out of item stack holder 29. Suction that is applied to suction ports on suction surface 58 may hold bottom item 30a to suction surface 58.

FIG. 5B schematically illustrates an example of the robotic arm shown in FIG. 5A when gripping a product item removed from a stack.

Suction that is applied to suction surface 58 may hold product item 30 (e.g., a bottom item 30a that was removed by grasping assembly 54 from an item stack holder 29, or any other product item 30) to suction surface 58. Robotic arm 24 may be controlled to move the held product item 30 to a target surface (e.g., item conveyor 14 or another surface3) onto which grasping assembly 54 is to place the held product item 30. For example, when grasping assembly 54 has been manipulated to the target surface, rotation mechanism 57 may be operated to rotate grasping assembly 54 such that suction surface 58 and the held product item 30 are below the remainder of grasping assembly 54. The suction that is applied to suction surface 58 may then be interrupted so as to release product item 30 from suction surface 58, thus depositing product item 30 onto the target surface.

In some examples, circularly-arranged product selection system 12 is configured to successively fill single orders by selecting product items 30 of a single order and conveying the selected product items 30 to a collection container 18 for collecting product items 30 for the single order. In other examples, a circularly-arranged product selection system may be configured to concurrently fill more than one order.

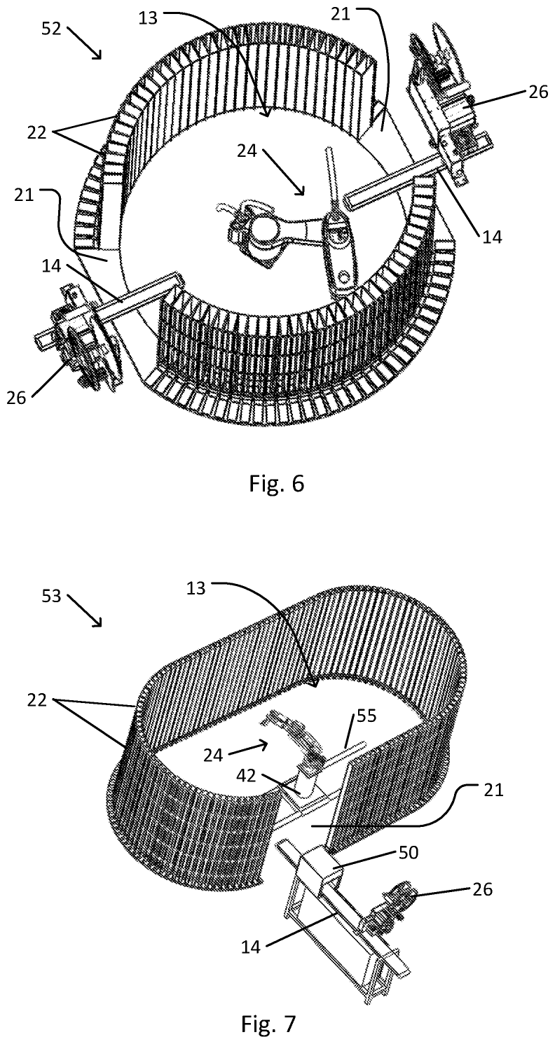

FIG. 6 schematically illustrates an example of a variant with two conveyors of the circularly-arranged product selection system shown in FIG. 2A.

In the example shown, circularly-arranged product selection system 52 is configured to collect product items 30 to concurrently fill two orders.

Circularly-arranged product selection system 12 includes a single robotic arm 24 that is configured to collect product items 30 that are dispensed by item dispensers 22. The dispensed product items 30 may be associated with either one of two orders. Robotic arm 24 may be controlled by controller 20 to grip a dispensed product item 30 and to place the gripped product item 30 on an item conveyor 14 that has been designated by controller 20 for filling one of the two orders. The product item 30 that was placed on one of item conveyors 14 may be conveyed via the associated conveyor gap 21 to a collection container 18 at the distal end of that item conveyor 14.

For example, controller 20 may control operation of robotic arm 24 and item dispensers 22 in accordance with an algorithm that may facilitate rapid fulfillment of both orders (e.g., based on location of a particular item dispenser 22 relative to the appropriate item conveyor 14, a current position of gripper 40 of robotic arm 24, or other considerations).

In other examples, a circularly-arranged product selection system may include more than two item conveyors 14, e.g., to enable concurrent fulfillment of more than two orders.

In another example, robotic arm 24 may be translatable, e.g., to enable robotic arm 24 to grasp objects from an arrangement of item storage units in which some of the item storage units cannot be reached by a stationary (non-translatable) robotic arm 24.

FIG. 7 schematically illustrates an example of a variant of the product selection system shown in FIG. 2A with a translatable robotic arm.

In the example shown, the item storage units of product selection system 53 are in the form of a plurality of item dispensers 22 that surround central space 13 except at conveyor gap 21. The arrangement of item dispensers 22 is elongated in one dimension to form a rectangular shape with rounded ends. In other examples, the item storage units may include item stack holders 29 or another type of storage unit.

Due to the elongation in one dimension, robotic arm 24, even when maximally extended, cannot remove product items 30 from all item dispensers 22 when arm base 42 of robotic arm 24 is at a single location relative to item dispensers 22. Accordingly, arm base 42 is configured to be translatable along track 55. For example, arm base 42 may include motorized wheels or rollers to propel arm base 42 along track 55. In another example, track 55 may include cables, belts, chains, or other structure that may engage or be attached to corresponding structure on arm base 42 to move arm base 42 along track 55.

In the example shown, track 55 is linear along the elongated dimension of the arrangement of item dispensers 22. In other examples, a track may be curved or otherwise parallel the arrangement of item dispensers 22 so as to enable translation of arm base 42 such that robotic arm 24 may remove a product item 30 from all item storage units in an arrangement of item storage units.

In the examples shown in FIGS. 2-6, item dispensers 22 are depicted as identical to one another. In other examples, item dispensers may differ from one another (e.g., in width, length, and height of opening 36, or otherwise), e.g., to accommodate product items 30 of different sizes or shapes.

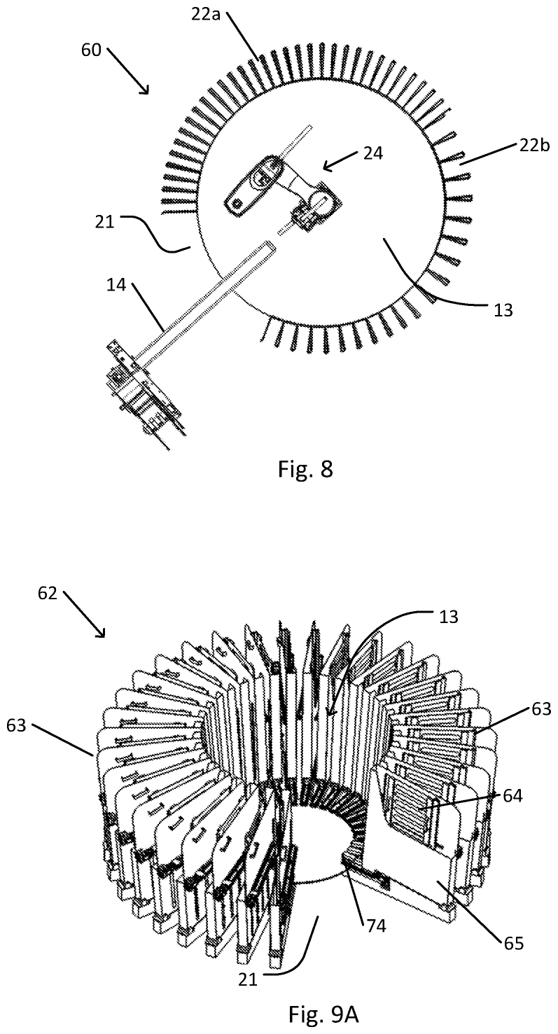

FIG. 8 is a schematic top view of a variant of the circularly-arranged product selection system shown in FIG. 2, with dispensers of varying width.

In circularly-arranged product selection system 60, differently sized product items 30 may be dispensed by different types of item dispensers 22a and 22b. In the example shown, item dispensers 22a and 22b are depicted as differing from one another in their dimensions (e.g., width and length). Controller 20 may be configured to direct robotic arm 24 to grip and product item 30, based on the configuration of an item dispenser 22a or 22b that dispensed that product item 30.

In the example shown, item dispensers 22a are depicted as grouped together in one part of circularly-arranged product selection system 60, which item dispensers 22b are depicted as grouped together in another part of circularly-arranged product selection system 60. In other examples, differently configured item dispensers may be interspersed among one another, or otherwise arranged about central space 13.

In some embodiments, item dispensers may be configured to facilitate continuous dispensing of product items 30, and to facilitate reloading of the dispensers.

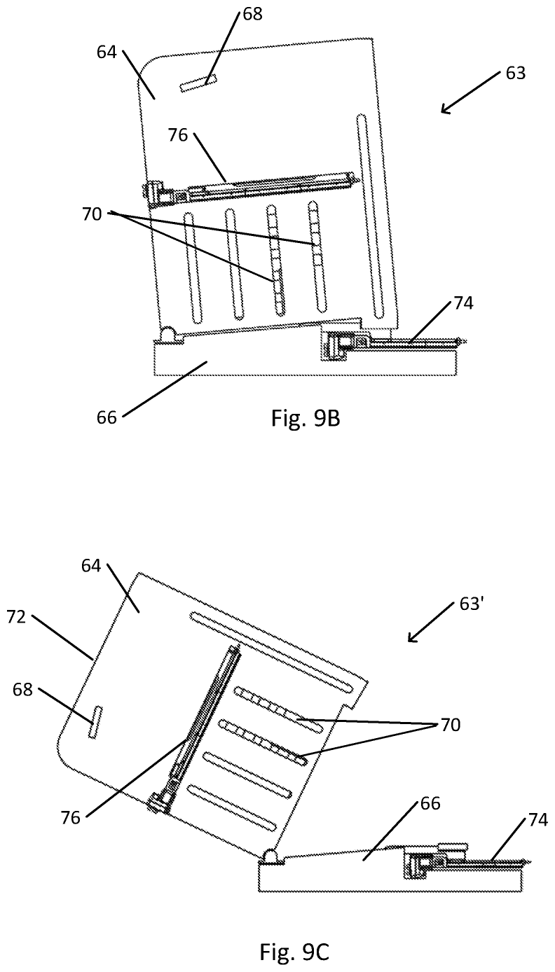

FIG. 9A is a schematic view of a variant of the circularly-arranged product selection system shown in FIG. 2, with items stored in a two-dimensional array in dispenser magazines. FIG. 9B schematically illustrates a dispenser magazine of the circularly-arranged product selection system shown in FIG. 9A.

In circularly-arranged product selection system 62, a plurality of item dispensers 63 are arranged in an approximately circular arrangement about central space 13. Product items 30 may be stored in a two-dimensional arrangement within dispenser magazine 64, enclosed in casing 65 of each item dispenser 63. In the example shown, each dispenser magazine 64 is mounted on a dispenser base 66. In other examples, a dispenser magazine 64 may be otherwise mounted.

. In one example, product items 30 may be stored within dispenser magazine 64 in one or more vertical stacks 70. Dispenser mechanism 74 may be configured to dispense a product item 30 that is stored at the bottom of an innermost vertical stack 70 that is nearest to dispenser mechanism 74. When all product items 30 have been dispensed from the innermost vertical stack 70, advancing mechanism 76 (e.g., including a spring-loaded surface or piston, an electromechanical mechanism, or other mechanism) within dispenser magazine 64 may displace one or more other vertical stacks 70 of product items 30 within dispenser magazine 64 inward toward central space 13 (e.g., through the width of one vertical stack 70). On outward tilt of dispenser magazine 64 on dispenser base 66 relative to the vertical may enable product items 30 that are stored within vertical stacks 70 to remain in stable stacks during operation of item dispenser 63.

In other example, a horizontal pushing mechanism may advance a product item 30 to a top position within a vertical stack 70 of dispenser magazine 64 whenever a product item 30 is dispensed from the bottom of that vertical stack 70. Thus, the stock of product items 30 within dispenser magazine 64 may be successively depleted first from the uppermost rows, and afterward from successively lower rows. In other examples, dispenser magazine 64 may include another type of storage arrangement and dispensing mechanism.

Item array dispenser 64 may be tiltable to facilitate replenishment of stored product items 30 within item array dispenser 64.

FIG. 9C schematically illustrates reloading of the dispenser magazine shown in FIG. 9B.

As shown, dispenser magazine 64 of item dispenser 63′ has been tilted outward, e.g., using handle 68. When dispenser magazine 64 is tilted outward, product items 30 may be placed into dispenser magazine 64 via loading opening 72. Internal structure of dispenser magazine 64 may be configured to facilitate loading of product items 30 into dispenser magazine 64 in an orderly manner. For example, after loading dispenser magazine 64 with product items 30 via loading opening 72, dispenser magazine 64 may be tilted forward to the configuration shown in FIG. 9B. When dispenser magazine 64 is tilted forward, structure within dispenser magazine 64 may facilitate or ensure self-organization of product items 30 into orderly rows and vertical stacks 70 within dispenser magazine 64. Loading product items 30 in an orderly manner may enable or facilitate operation of dispenser mechanism 74.

A controller 20 that is associated with circularly-arranged product selection system 62 may be configured to prevent operation of dispenser mechanism 74 when dispenser magazine 64 is tilted outward. For example, controller 20 may be configured to change, when possible, an order of selection of product items 30 from a dispenser magazine 64 that is being reloaded of an order in order to avoid delay in filling the order.

In some examples, product items 30 may be stored within a circularly-arranged product selection system within a tiered arrangement of bins.

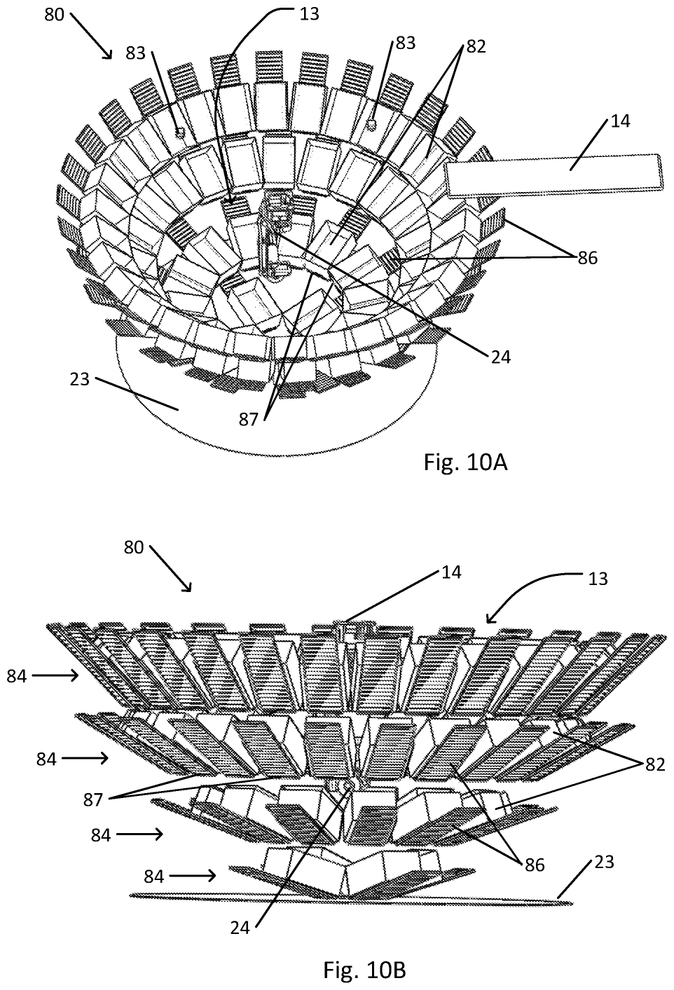

FIG. 10A schematically illustrates an example of a circularly-arranged product selection system in which items are stored in open bins. FIG. 10B is a schematic side view of the circularly-arranged product selection system shown in FIG. 10A.

In the example shown, circularly-arranged product selection system 80 stores product items 30 in a plurality of item storage units in the form of open storage bins 82 in a tiered concave (bowl-like) arrangement about central space 13 and robotic arm 24. Typically, product items 30 may be randomly oriented and distributed within each open storage bin 82. Robotic arm 24 may be controlled by controller 20 to grip a product item 30 from an open storage bin 82 and place the gripped product item 30 on item conveyor 14.

In the example shown, sensors in the form of cameras 83 are mounted above open storage bins 82. Controller 20 may analyze images that are acquired by cameras 83 to identify a particular product item 30 in an open storage bin 82. Controller 20 may then utilize data from cameras 83 to guide and control robotic arm 24 to remove an identified product item 30 from an open storage bins 82 and place the removed product item 30 on item conveyor 14.

In another example, robotic arm 24 may be provided with sensors that enable robotic arm 24 or controller 20 to identify a product item 30 in an open storage bin 82, identify an orientation of the identified product item 30, and guide a gripper 40 of robotic arm 24 to grip and manipulate the identified product item 30, and to place the gripped product item 30 (e.g., at a preferred location and in a preferred orientation) on item conveyor 14.

In the example shown, each open storage bin 82 is supported by a separate support rack 86. Support rack 86 may be configured to facilitate temporary outward displacement of an open storage bin 82. For example, each support rack 86 may include rollers or other structure to facilitate outward and inward displacement of each open storage bin 82. When open storage bin 82 is displaced outward, an empty open storage bin 82 may be removed and replaced with a full open storage bin 82, or product items 30 may be loaded or reloaded into the displaced open storage bin 82. For example, product items 30 may be quickly dumped into an open top of the displaced open storage bin 82 in a random fashion. Thus, the amount of time during which open storage bin 82 must be displaced outward to enable reloading or refilling may be minimized. Minimizing the time for reloading open storage bin 82 may enable or minimally disturb continuous operation of circularly-arranged product selection system 80.

As another example, an open storage bin 82 may include a carton in which one or more types of product items 30 are shipped from a supplier, or that was filled within a facility in which circularly-arranged product selection system 80. In this example, when the supply of product items 30 in an open storage bin 82 is depleted, the empty open storage bin 82 may be discarded and replaced with another, e.g., full, open storage bin 82.

In the example shown, open storage bins 82 and support racks 86 are arranged in a plurality of distinct tiers 84 about central space 13. Other arrangements of support racks 86 and open storage bins 82 are possible.

In the example shown, item conveyor 14 is located above the uppermost tier 84 of open storage bins 82 and support racks 86. Thus, no gap is necessary to allow for passage of item conveyor 14 between open storage bins 82. In other examples, item conveyor 14 may be located at the height of, or below, one or more tiers 84 of circularly-arranged product selection system 80 (possibly necessitating a gap in the arrangement of one or more tiers 84 of open storage bins 82, e.g., similar to conveyor gap 21), or below all open storage bins 82 (e.g., below floor surface 23).

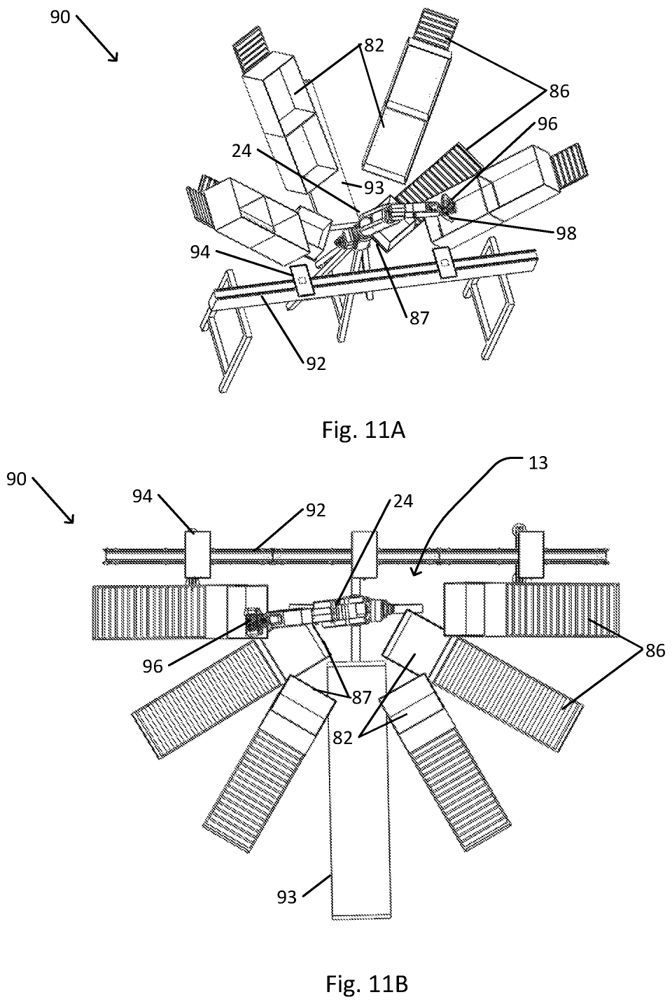

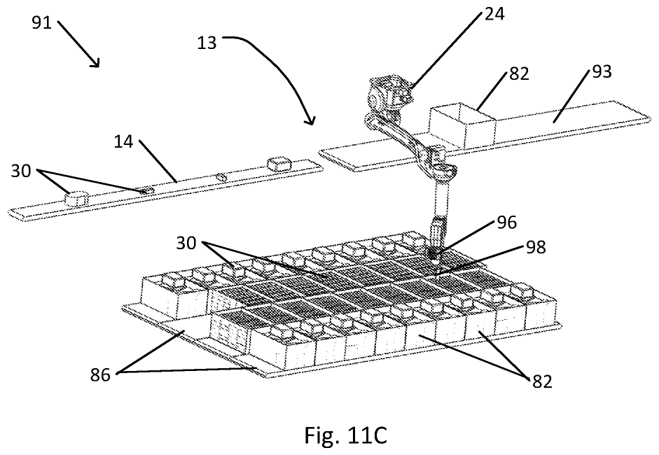

FIG. 11A schematically illustrates a variant of the circularly-arranged product selection system shown in FIG. 10A, in which the open bins are arranged on one side of a conveyor track. FIG. 11B is a schematic top view of the circularly-arranged product selection system shown in FIG. 11A.

In the example shown of product selection system 90, a plurality of open storage bins 82 are arranged on a plurality of support racks 86 partially surrounding central space 13 on one side of conveyor track 92. Robotic arm 24 may be controlled to identify, from among product items 30 that are stored within one or more open storage bins 82, a particular type product item 30, e.g., that was specified in an order, and grip the identified product item 30. Robotic arm 24 may then be controlled to place the gripped product item 30 on a cart 94 that is configured to travel along conveyor track 92. For example, each cart 94 may be assigned to carry product items 30 that are part of a single order. Alternatively or in addition, each cart 94 may be operated to travel along conveyor track 92 to a location where product items 30 of a single order are removed from two or more carts 94 for assembly into a single order.

In the example shown, the distal end of robotic arm 24 is provided with a sensor assembly 96 and a suction gripper 98. Sensor assembly 96 includes one or more sensors that are configured to sense data that may be analyzed to identify a product item 30 that is stored in a storage bin 82. Alternatively or in addition, sensors may be placed elsewhere in product selection system 90. For example, one or more cameras may be mounted above or to the side of support racks 86 so as to identify the contents of one or more storage bins 82.

For example, sensor assembly 96 may include one or more imaging devices (e.g., one or more video cameras). In some cases, imaging devices of sensor assembly 96 may include a stereo pair of cameras whose acquired images may be analyzed to yield a three-dimensional description of imaged product items 30. Images that are acquired by an imaging device of sensor assembly 96 may be analyzed by a processor (e.g., that is associated with controller 20, e.g., within robotic arm 24) to identify imaged product items 30. For example, one or more image analysis techniques may be applied to identify a shape, size, color, or other identifying characteristic of a sensed product item 30. Alternatively or in addition, image analysis may detect one or more identifying markings on a sensed product item 30. Identifying markings may include, for example, alphanumeric characters, symbols, pictures, coloring, barcodes, or other visually detectable identifying markings.

Alternatively or in addition, sensor assembly 96 may include one or more of a range sensor, proximity sensor, barcode scanner, RFID reader, or other sensor that may assist in identifying a particular product item 30 and in determining the location of the identified product item 30 relative to suction gripper 98.

When a particular product item 30 that is to be selected is identified, robotic arm 24 may be operated, e.g., using sensor data that is acquired by sensor assembly 96, to direct suction gripper 98 to a surface of the identified product item 30. Robotic arm 24 may be operated to apply suction to suction gripper 98, thus applying suction that holds the identified product item 30 to suction gripper 98. Alternatively or in addition, robotic arm 24 may be provided with manipulable fingers or other grasping structure for grasping a product item 30.

Robotic arm 24 may then be operated to move the product item 30 that is gripped by suction gripper 98 to the appropriate cart 94. When the gripped product item 30 has been moved to cart 94, robotic arm 24 may be operated to cease the application of suction to suction gripper 98 (or open fingers or other grasping structure), thus releasing product item 30 onto cart 94.

In the example shown, product selection system 90 is configured for disposable open storage bins 82. For example, open storage bin 82 may include a carton, crate, or similar disposable container that is configured for a single use by open storage bin 82. A typical disposable open storage bin 82 may include a carton or other container in which a plurality of one or more types of product items 30 are delivered to an order fulfillment facility (e.g., a store, warehouse, or other facility) from a supplier of product items 30.

When an open storage bin 82 is to be added to product selection system 90, open storage bin 82 may be placed onto a support rack 86. Typically, support rack 86 is sloped downward to central space 13. Thus, an open storage bin 82 that is placed on a distal (from central space 13) end of support rack 86 may slide downward and inward until that open storage bin 82 is stopped by stopper 87 (or by another open storage bin 82 that is already held in place by stopper 87) at a proximal end of support rack 86. For example, support rack 86 may include rollers (as in the example shown), an air cushion, low friction coatings, or other structure that facilitates downward sliding of open storage bin 82 on support rack 86. Stopper 87 may include a rim or other upward projection from support rack 86 that prevents or inhibits further downward and inward sliding of open storage bin 82 on support rack 86 past stopper 87. (The description of operation of support racks 86 may also be relevant to circularly-arranged product selection system 80 as illustrated in FIGS. 10A and 10B.)

For example, a sensed image of the interior of an open storage bin 82, or other data that is sensed by sensor assembly 96, may indicate that all product items 30 (or all product items 30 of a particular type) have been removed from an open storage bin 82. In the example shown, robotic arm 24 may lift (e.g., by applying suction when suction gripper 98 is in contact with an interior surface or other surface of the emptied open storage bin 82, or otherwise) open storage bin 82 off of support rack 86 and place the empty open storage bin 82 onto disposal conveyor 93. For example, disposal conveyor 93 may be operable to convey an empty open storage bin 82 to a disposal location where empty open storage bins 82 are disposed of, or prepared for recycling or reuse.

Alternatively or in addition, an empty open storage bin 82 may be disposed of into central space 13. For example, stopper 87 may be retractable into support rack 86 to enable the empty open storage bin 82 to slide downward off of support rack 86.

FIG. 11C schematically illustrates a variant of the circularly-arranged product selection system shown in FIG. 11A.

In the example shown of product selection system 91, a plurality of open storage bins 82 are arranged on a plurality of support racks 86 (only some being shown for purposes of illustration) partially surrounding central space 13. Although support racks 86 are shown as horizontal for the sake of simplicity, support racks 86 are typically slanted as illustrated in FIG. 11A. Robotic arm 24, located in central space 13 and equipped with sensor assembly 96 and suction gripper 98, may be operated to remove a particular product item 30 from a storage bin 82 and to place the removed product item 30 onto item conveyor 14.

Robotic arm 24 may be further controlled to identify an empty storage bin 82, or a storage bin 82 that otherwise (e.g., containing a discontinued or expired product item 30) is to be removed from a support rack 86. Robotic arm 24 may then remove the identified storage bin 82 from the support rack 86 that supports that storage bin 82 and place the removed storage bin 82 onto disposal conveyor 93. In the example shown, disposal conveyor 93 is at the same height as item conveyor 14.

Although certain features (e.g., tiers 84, item conveyor 14, floor surface 23, a circular arrangement of open storage bins 82, and other features) were described in connection with circularly-arranged product selection system 80, and other features (e.g., disposal conveyor 93, stopper 97, conveyor track 92, cart 94, sensor assembly 96, sensor assembly 96, and other features) were described in connection with product selection system 90, those features may be incorporated in either circularly-arranged product selection system 80, or in product selection system 90 or 91. Features described in connection with structure of and operation of robotic arm 24 may be incorporated into robotic arm 24 in any of the described systems (e.g., one or more of circularly-arranged product selection systems 12, 52, 60, 62, and 80, product selection systems 53 and 90, or similar product selection systems).

Controller 20 of a circularly-arranged product selection system may operate one or more components of the selection system, e.g., robotic arm 24, item conveyor 14, and other components, in accordance with a control method.

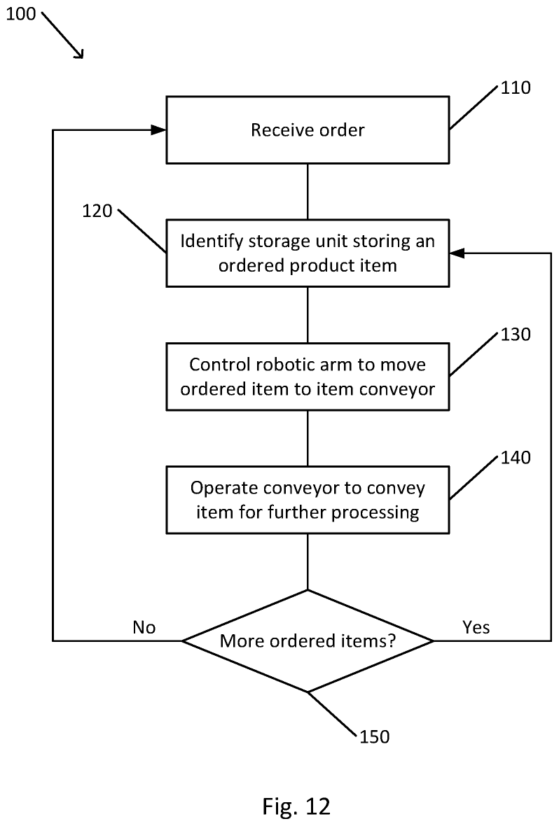

FIG. 12 is a flowchart depicting a method of operation of a circularly-arranged product selection system, in accordance with an embodiment of the invention.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Selection system control method 100 may be executed by a data processing unit of one or more components of controller 20 of a circularly-arranged product selection system. For example, selection system control method 100 may be executed continuously during operation of circularly-arranged product selection system, e.g., one or more of circularly-arranged product selection systems 12, 52, 60, 62, or 80, or another type of circularly-arranged product selection system. In other examples, execution of selection system control method 100 may be initiated by user input, or may be triggered by approach of a collection container 18 to an item conveyor 14 of the circularly-arranged product selection system.

An order may be received that indicates what product items 30 are to be placed in a particular collection container 18 (block 110). For example, an identifier of a collection container 18 may be sensed by a sensor of an order fulfillment system 10. Controller 20 may receive a listing of product items 30 that are to be placed in that collection container 18 via user input to controller 20, controller 20 may retrieve an order from a database of orders that is stored on a data storage unit of, or that is accessible by, controller 20, or an order may be otherwise received. In some cases, e.g., where a product item 30 includes a prescribed medication, the received order may include physician-provided information regarding use of the medication, or other information that may be printed on a label that is to be affixed to that product item 30.

A storage unit within the circularly-arranged product selection system of a product item 30 that is listed in the received order may be identified (block 120). For example, controller 20 may retrieve a location or identification of a storage unit in which a particular product item 30 is stored from a database of the storage units. The database may include other information regarding each product item 30. Such additional information may include markings that identify each product item 30, a shape, size, and weight of each product item 30, any special handling instructions or warnings regarding each product item 30, or other information.

The storage unit may include an item dispenser 22 or 63 in which a particular product item 30 is stored, an open storage bin 82 in which a particular product item 30 is stored, or another type of item storage unit.

Controller 20 may control robotic arm 24 to take the ordered product item 30 from the identified storage unit and place the object on item conveyor 14 (block 130).

For example, controller may operate dispensing piston 28 of an item dispenser 22, dispenser mechanism 74 of an item dispenser 63, or another dispensing mechanism to dispense a product item 30. Controller 20 may concurrently or subsequently operate robotic arm 24 to cause gripper 40 to grip the dispensed product item 30. In another example, controller 20 may operate robotic arm 24 to cause gripper 40 to identify and grip a product item 30 that is in an open storage bin 82.

Once gripper 40 grips the dispensed or identified product item 30, controller 20 may operate robotic arm 24 to place the gripped product item 30 on a proximal end of item conveyor 14. In some cases, robotic arm 24 may be operated to place the gripped product item 30 onto item conveyor 14 with a predetermined orientation relative to item conveyor 14.

Controller 20 may operate item conveyor 14 to convey a product item 30 that was placed on item conveyor 14 for further processing (block 140). For example, item conveyor 14 may include a conveyor belt, track (e.g., a cart 94 travelling along a conveyor track 92), chute, or other mechanism for conveying a product item 30 placed by robotic arm 24 at a proximal location on item conveyor 14, to a collection container 18 at a distal location on or near item conveyor 14, or for other processing.

A product item 30 being conveyed by item conveyor 14 may pass by one or more sensors 50. A sensor 50 may be configured to sense one or more physical characteristics of product item 30 (e.g., shape, dimensions, orientation, weight, color, or other physical characteristics), sense one or more identifying markings on product item 30 (e.g., barcode, alphanumeric characters, symbols, RFID tag, graphics or artwork, or other identifying markings), may verify the integrity of packaging of product item 30, or other properties of product item 30. The sensing may cover all or some sides of product item 30.

A product item 30 being conveyed by item conveyor 14 may be labeled by labeler 26. For example, labeler 26 may be operated by controller 20 to print one or more labels (e.g., to display specific information regarding product item 30, such as pricing, prescription information, gift or other messages, or other specific information), select one or more preprinted or otherwise previously prepared labels (e.g., containing standard cautions or handling instructions), or otherwise ready a label for affixing to product item 30. Controller 20 may operate labeler 26 to affix a label to product item 30 (e.g., using an adhesive, attaching a tag, or otherwise).

At a distal location on item conveyor 14, product item 30 may drop into, or may otherwise be deposited into, a collection container 18 that is assigned to collect one or more product items 30 of one or more orders. Alternatively or in addition, item conveyor 14 may convey product items 30 to a location where other manual or automatic processing is performed. For example, product items 30 that are associated with an order may be packed in an orderly fashion within a container for shipping to a party that placed the order.

If the order includes one or more additional product items 30 that have not yet been placed onto item conveyor 14 (block 150), the storage location of another product item 30 may be identified (returning to block 120).

If all ordered product items 30 have been placed on item conveyor 14 (and conveyed for further processing), controller 20 of the circularly-arranged product selection system may begin filling another order (returning to block 110). The filled collection container 18 may be transported away from item conveyor 14 for further processing (e.g., addition of product items 30 by another circularly-arranged product selection system, manual loading of additional items, visual or automatic inspection, shipping, repacking, or other processing).

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A product selection system comprising:
a robotic arm, the robotic arm controllable to grip and manipulate product items of different types that are stored in a plurality of storage units that at least partially surround a central space in which the robotic arm is configured to operate, each storage unit configured to store a plurality of the product items; and
a controller that is configured to control the robotic arm to remove each product item of an order of a plurality of the product items that are stored in the plurality of the storage units from the storage unit in which that product item is stored to an item conveyor for assembling of all of the plurality of product items of the order.

2. The system of claim 1, further comprising the plurality of storage units, wherein each of the storage units is configured to hold a stack of the product items of a single type, the different types of the product items being stored in different storage units of the plurality of storage units.

3. The system of claim 2, wherein each of the storage units comprises a dispenser that is configured to dispense a product item that is stored within that dispenser.

4. The system of claim 3, wherein a mechanism for dispensing a stored product item from the vertical stack comprises a piston that is configured to push a product item of the product items out of the stack through an opening in the dispenser toward the central space.

5. The system of claim 2, wherein the dispenser comprises a magazine configured to store a plurality of the stacks of the product items.

6. The system of claim 5, wherein the magazine comprises an advancing mechanism to displace a stack of the plurality of stacks when all of the product items stored in one of the stacks have been dispensed.

7. The system of claim 2, wherein the robotic arm is configured to remove a product item at a bottom of the stack and to grip the removed product item.

8. The system of claim 1, further comprising a plurality of support racks, each support rack configured to support one or more storage units, each storage unit comprising an open storage bin configured to store a plurality of the product units of one or more types, wherein the controller is configured to operate the robotic arm to remove a selected product item from a plurality of product items that are stored in the storage bin.

9. The system of claim 8, further comprising one or more sensors that are configured to sense data that is analyzable to identify a selected product item of the plurality of product items, wherein the controller is configured to analyze the sensed data to identify the selected product item.

10. The system of claim 9, wherein a sensor of the one or more sensors comprises a camera, the data sensed by the camera comprising image data.

11. The system of claim 9, wherein a sensor of the one or more sensors is mounted on the robotic arm.

12. The system of claim 8, wherein the plurality of support racks are arranged in a plurality of tiers about the central space.

13. The system of claim 8, wherein each support rack of the plurality of support racks is sloped downward toward the central space such that when the storage bin is placed on a distal end of the support rack, the storage bin slides downward and inward toward the central space.

14. The system of claim 13, wherein a proximal end of the support rack includes a stopper that is configured to stop the inward sliding of the storage bin.

15. The system of claim 13, wherein the support rack includes rollers to facilitate the inward sliding of the storage bin.

16. The system of claim 8, further comprising a disposal conveyor that is configured to convey an empty storage bin that is placed on the disposal conveyor to a disposal location.

17. The system of claim 1, further comprising the item conveyor.

18. The system of claim 17, further comprising a sensor to sense one or more properties of a selected product item that has been placed by robotic arm on the on the item conveyor.

19. The system of claim 17, further comprising a labeler to label a selected product item that has been placed by the robotic arm on the item conveyor.

20. The system of claim 1, wherein the different types of the product items differ from one another by one or more characteristics selected from a group of characteristics consisting of size, shape, material, weight and external appearance.

21. A method for controlling operation of a product selection system, the method comprising, by a controller:
identifying a storage unit of a plurality of storage units in which each type of product item of an order of a plurality of the product items of different types that are stored in the plurality of the storage units is stored;
operating a robotic arm that is located in a central space that is at least partially surrounded by the storage units to move each of the plurality of product items of the order from the storage unit in which that product item is stored to an item conveyor; and
operating the item conveyor to convey each listed product item that is placed on the item conveyor for assembling of all of the plurality of product items of the order.
